(19) United States
(12) Patent Application Publication
(10) Pub. No.: US 2018/0267758 A1
(43) Pub. Date: Sep. 20, 2018

(54) Joining Control Method, Device and Joined Screen System

(71) Applicant: BOE Technology Group Co., Ltd., Beijing (CN)

(72) Inventors: Tianyue Zhao, Beijing (CN); Ran Duan, Beijing (CN)

(73) Assignee: BOE Technology Group Co., Ltd., Beijing (CN)

(21) Appl. No.: 15/542,154

(22) PCT Filed: Aug. 16, 2016
(86) PCT No.: PCT/CN2016/095557

§ 371 Date: Jul. 7, 2017

(30) Foreign Application Priority Data
Oct. 30, 2015 (CN) 201510729185.4

(51) Int. Cl. G06F 3/147; G06T 3/00

(52) U.S. Cl. CPC G06F 3/147; G06T 2200/32; G06T 3/0068

(57) ABSTRACT

A joining control method, a joining control device and a joined screen system, the joining control method including: outputting a first test image data to a joined screen according to the correspondence between images and ports; acquiring feedback image data, the feedback image being an image which is displayed on the joined screen and corresponds to the first test image data; if a feedback sub-image in the feedback image is identical to a test sub-image in the first test image but in a different position, establishing correspondence between the output port of the test sub-image data and the position of the feedback sub-image so as to update the correspondence between the images and the ports. The method can automatically adjust the output signal of the output ports, such that the joined screen can display the correct picture without the need to repeatedly plug and unplug cables.

### TECHNICAL FIELD

Embodiments of the present disclosure relate to a splicing control method, a splicing control device and a splicing screen system.

### BACKGROUND

In order to satisfy the requirement of displaying a large image, a splicing screen system emerges and develops rapidly. The splicing screen system comprises a splicing control device and a splicing screen. The splicing screen is generally formed by the splicing of a plurality of sub-screens. The splicing control device includes a plurality of output interfaces, and each output interface is correspondingly connected with one sub-screen through one cable.

Due to the popularization of ultra high-definition (HD) splicing screen systems, the number of the output interfaces of the splicing screen control device is in sharp rise, so the connection error between the output interfaces and the sub-screens tends to occur. Taking a splicing screen system, in which a splicing screen is composed of 3*3 sub-screens and a splicing screen control device includes 9 output interfaces, as an example, the splicing screen control device includes interfaces 1, 2 . . . 9, and the splicing screen includes sub-screens 1, 2 . . . 9, in which the interfaces 1, 2 . . . 9 are respectively connected with the sub-screens 1, 2 . . . 9. In actual operation, as the number of the interfaces is numerous, connection error tends to occur. For instance, the interface 1 is connected with the sub-screen 2 and the interface 2 is connected with the sub-screen 1. In this case, the sub-screen 1 and the sub-screen 2 respectively display images corresponding to image data outputted by the interface 2 and the interface 1, so display error of the splicing screen can be caused. In order to correct the error, the cable re-plugging means is mostly adopted for corresponding adjustment in the prior art. In the case of more interface connection errors, repeated cable plugging is required, so the consumption time can be long and the service life of the cable can be reduced.

### SUMMARY

In order to solve the above problem, the embodiment of the present disclosure adopts the following technical proposal:

According to at least one embodiment of this disclosure, a splicing control method is provided, comprising: outputting first test image data to a splicing screen according to image interface corresponding relationships, in which the image interface corresponding relationships refer to corresponding relationships between positions of sub-images in an image to be outputted and output interfaces of the splicing control device, and a first test image includes N test sub-images; acquiring feedback image data, in which a feedback image is an image, corresponding to the first test image data, displayed by the splicing screen, and includes N feedback sub-images; and creating corresponding relationships between output interfaces of test sub-image data and positions of the feedback sub-images, so as to update the image interface corresponding relationships, if a feedback sub-image in the feedback image and a test sub-image in the first test image have same pattern but different positions.

For example, before the step of allowing the splicing control device to output the first test image data to the splicing screen according to the image interface corresponding relationships, the method further comprises: selecting a first test image including N test sub-images according to N splicing sub-screens in the splicing screen.

For example, after the step of allowing the splicing control device to output the first test image data to the splicing screen according to the image interface corresponding relationships, if the splicing screen does not display an image corresponding to the first test image data, the method further comprises: sending a reset signal to the splicing screen, so that the splicing screen can reacquire and display the first test image data.

For example, after the step of creating the corresponding relationships between the output interfaces of the test sub-image data and the positions of the feedback sub-images, so as to update the image interface corresponding relationships, the method further comprises: storing updated image interface corresponding relationships.

For example, after the step of creating the corresponding relationships between the output interfaces of the test sub-image data and the positions of the feedback sub-images, so as to update the image interface corresponding relationships, the method further comprises: allowing the splicing control device to output second test image data to the splicing screen according to the updated image interface corresponding relationships, so as to detect whether the updated image interface corresponding relationships are correct.

According to at least one embodiment of this disclosure, a splicing control device is provided, comprising: output interfaces; a control output module configured to output first test image data to a splicing screen through the output interfaces according to image interface corresponding relationships, in which the image interface corresponding relationships refer to corresponding relationships between positions of sub-images in an image to be outputted and the output interfaces, and the first test image includes: N test sub-images; a feedback module configured to acquire feedback image data, in which a feedback image is an image, corresponding to the first test image data, displayed by the splicing screen, and includes N feedback sub-images; and a data processing module configured to create corresponding relationships between output interfaces of test sub-image data and positions of the feedback sub-images, so as to update the image interface corresponding relationships, if one feedback sub-image in the feedback image and one test sub-image in the first test image have same pattern but different positions.

For example, the data processing module includes: a determination unit configured to determine whether the feedback sub-image in the feedback image and the test sub-image in the first test image have same pattern but different positions; and an adjustment unit configured to create the corresponding relationships between the output interfaces of the test sub-image data and the positions of the feedback sub-images, so as to update the image interface corresponding relationships.

For example, the splicing control device further comprises: a selection module configured to select a first test image including N test sub-images according to N splicing sub-screens in the splicing screen.

For example, the splicing control device further comprises: a reset module configured to send a reset signal to the splicing screen if the splicing screen does not display an image corresponding to the first test image data, so that the splicing screen can reacquire and display the first test image data.

For example, further comprising: a storage module configured to store updated image interface corresponding relationships.

According to at least one embodiment of this disclosure, a splicing screen system is provided, comprising the splicing control device and a splicing screen.

For example, the feedback module of the splicing control device is connected with the splicing screen through a serial bus.

### BRIEF DESCRIPTION OF THE DRAWINGS

In order to make the embodiments of the disclosure apparent, the drawings related to the embodiments of the disclosure will be described briefly. Apparently, the described embodiments are just a part of the embodiments of the disclosure. For those skilled in the art, he or she can obtain other figure(s) according to these figures, without any inventive work.

FIG. 1 is a flow diagram of a splicing control method provided by the embodiment of the present disclosure;

FIG. 2 is a schematic diagram illustrating image interface corresponding relationships in the embodiment of the present disclosure;

FIG. 3 is a schematic diagram illustrating the connection error of image interfaces;

FIG. 4 is a schematic diagram obtained after the automatic adjustment of the corresponding relationships of the image interfaces in FIG. 3;

FIG. 5 is a flow diagram of another splicing control method provided by the embodiment of the present disclosure;

FIG. 6 is a flow diagram of another splicing control method provided by the embodiment of the present disclosure;

FIG. 7 is a flow diagram of another splicing control method provided by the embodiment of the present disclosure;

FIG. 8 is a flow diagram of still another splicing control method provided by the embodiment of the present disclosure;

FIG. 9 is a schematic structural view of a splicing system provided by the embodiment of the present disclosure;

FIG. 10 is a schematic structural view of a data processing module in FIG. 9;

FIG. 11 is a schematic structural view of another splicing system provided by the embodiment of the present disclosure; and

FIG. 12 is a schematic structural view of still another splicing system provided by the embodiment of the present disclosure.

Reference numerals of the accompanying drawings:

1—output interface; 2—control output module; 3—feedback module; 4—data processing module; 41—determination unit; 42—adjustment unit; 5—selection module; 6—reset module; 7—storage module; 10—splicing control device; 11—splicing screen.

### DETAILED DESCRIPTION

The technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

First Embodiment

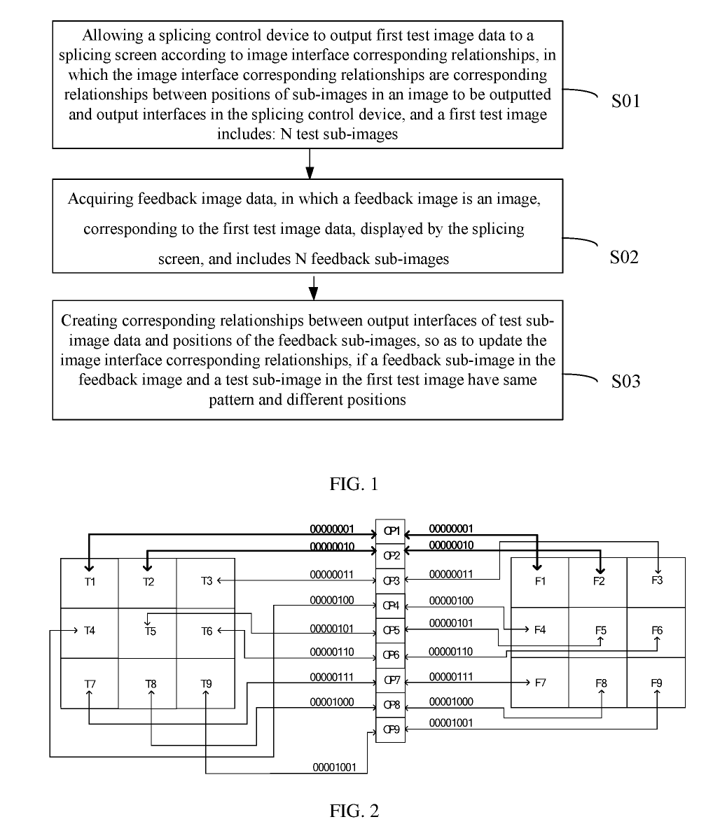

The embodiment of the present disclosure provides a splicing control method. As illustrated in FIG. 1, the method comprises:

S01: allowing a splicing control device to output first test image data to a splicing screen according to image interface corresponding relationships, in which the image interface corresponding relationships are corresponding relationships between positions of sub-images in an image to be outputted and output interfaces in the splicing control device, and a first test image includes: N test sub-images.

It should be noted that the specific number of test sub-images in a first test image is not limited in the embodiment of the present disclosure and may be determined according to the number of splicing sub-screens in the splicing screen. Illustratively, the splicing screen includes 9 sub-screens; the first test image may include 9 test sub-images; and each sub-screen correspondingly displays one test sub-image.

The image interface corresponding relationships refer to corresponding relationships between the positions of the sub-images in the image to be outputted and the image interfaces, and the position of each sub-image corresponds to one output interface. A pattern of the image to be outputted is not limited in the embodiment of the present disclosure. If the image to be outputted is the first test image, the position of each test sub-image may be set to be an address; subsequently, data corresponding to each address are transmitted to each output interface; and hence the image interface corresponding relationships can be achieved. Illustratively, as shown in FIG. 2, the image to be outputted is the first test image; the first test image includes 9 test sub-images T1, T2, . . . T9; positions of the 9 test sub-images may be respectively set to be 00000001, 00000010, 00000011, 00000100 . . . 00001001 (described by a binary system); and 9 output interfaces OP1, OP2 . . . OP9 respectively correspond to the addresses 00000001, 00000010 . . . 00001001.

S02: acquiring feedback image data, in which a feedback image is an image, corresponding to the first test image data, displayed by the splicing screen, and includes N feedback sub-images.

S03: creating corresponding relationships between output interfaces of test sub-image data and positions of the feedback sub-images, so as to update the image interface corresponding relationships, if a feedback sub-image in the feedback image and a test sub-image in the first test image have same pattern and different positions.

The position of the feedback sub-image in the feedback image has same meaning with the position of the test sub-image in the first test image, so no further description will be given here. The method may be implemented by software, hardware or firmware. For instance, the splicing control device may be implemented by a special processor chip (e.g., a programmable logic circuit) or a general processor chip (e.g., a CPU).

Detailed description will be given below to how to automatically adjust the output signal of the output interfaces in the splicing control method. FIG. 2 is a schematic diagram illustrating the correct connection between the splicing control device and the splicing screen. Description is given here by taking the following as an example: the first test image includes 9 test sub-images T1, T2 . . . T9 as shown in FIG. 2; addresses corresponding to positions of the 9 test sub-images T1, T2 . . . T9 are 00000001, 00000010 . . . 00001001; and 9 output interfaces OP1, OP2 . . . 0P9 are respectively adopted for output.

In the case of correct connection between the splicing screen and the interfaces of the splicing control device, a pattern displayed by the feedback image shall be the same with that of the first test image as shown in FIG. 2. For instance, the feedback image may include 9 feedback sub-images F1, F2 . . . F9 as shown in FIG. 2, in which the feedback sub-images F1, F2 . . . F9 and the test sub-images T1, T2 . . . T9 have same correspondingly displayed patterns.

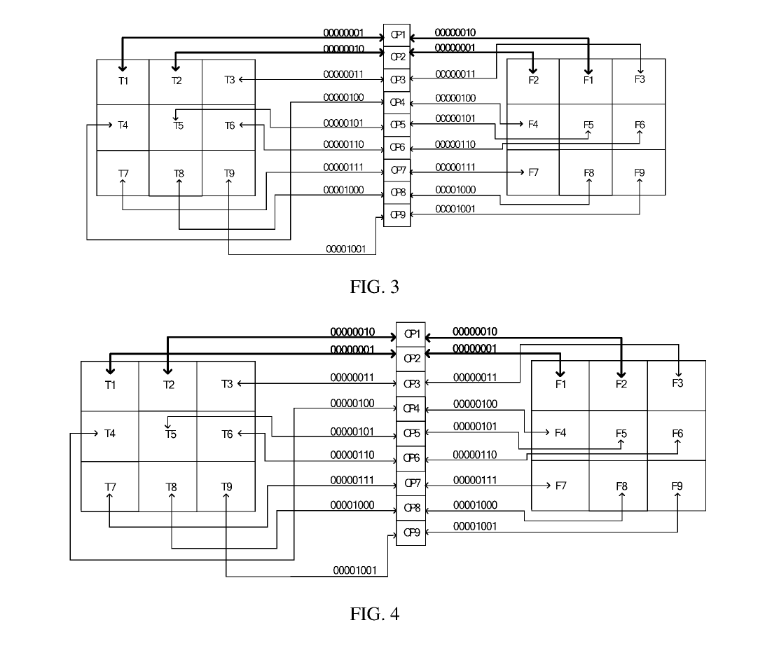

FIG. 3 is a schematic diagram illustrating the incorrect connection between the splicing control device and the splicing display. In the case of connection error between the splicing screen and the interfaces of the splicing control device, for instance, as shown in FIG. 3, there are errors on the connection relationships between the output interfaces OP1 and OP2 and the splicing sub-screens, and there is error on the pattern displayed by the feedback images. At this point, it can be obtained by comparison of the feedback image and the first test image that the test sub-image T1 and the feedback sub-image F1 and the test sub-image T2 and the feedback sub-image F2 have same pattern but different positions. Thus, the corresponding relationship between the position (00000001) of the test sub-image T1 and the output interface OP1 is adjusted to be the corresponding relationship between the position (00000010) of the feedback sub-image F1 and the output interface OP1. Similarly, the corresponding relationship between the position (00000010) of the test sub-image T2 and the output interface OP2 is adjusted to be the corresponding relationship between the position (00000001) of the feedback sub-image F2 and the output interface OP2. In this way, after the adjustment of the corresponding relationships of the images, as shown in FIG. 4, the output interface OP1 corresponds to the position address 00000010 of the test sub-image T2, and the output interface OP2 corresponds to the position address 00000001 of the test sub-image T1. Thus, a sub-screen connected with the output interface OP1 displays the feedback sub-image F2 in the feedback image, and a sub-screen connected with the output interface OP2 displays the feedback sub-image F1 in the feedback image, so the automatic adjustment of output signals of the output interfaces can be completed.

The embodiment of the present disclosure provides a splicing control method, which comprises: allowing a splicing control device to output first test image data to a splicing screen according to interface corresponding relationships; acquiring feedback image data; and creating corresponding relationships between output interfaces of test sub-image data and positions of feedback sub-images, so as to update the image interface corresponding relationships, if one feedback sub-image in the feedback image and a test sub-image in the first test image have same pattern but different positions. In the case of connection error between the splicing screen and the interfaces of the splicing control device, the splicing control method can automatically adjust output signals of the output interfaces, allow the splicing screen to display correct pattern without repeated cable plugging, and hence can simplify operation and save time.

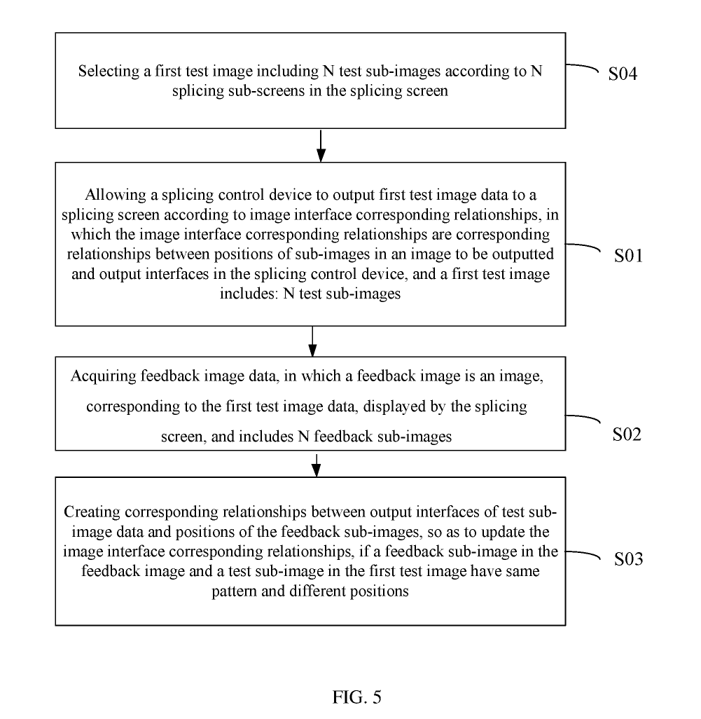

Illustratively, as shown in FIG. 5, before the step of allowing the splicing control device to output the first test image data to the splicing screen according to the image interface corresponding relationships in S01, the method further comprises:

S04: selecting a first test image including N test sub-images according to N splicing sub-screens in the splicing screen.

It should be noted that the specific number of the test sub-images in the first test image is not limited in the embodiment of the present disclosure. If the splicing screen includes 9 sub-screens, a first test image including 9 test sub-images is selected. The number of the test sub-images in the first test image is equal to the number of the splicing sub-screens in the splicing screen. The splicing control device can provide first test images including test sub-images of different numbers, and hence can be applied in splicing screen systems including sub-screens of different numbers. Thus, the application scope of the splicing control device can be widened.

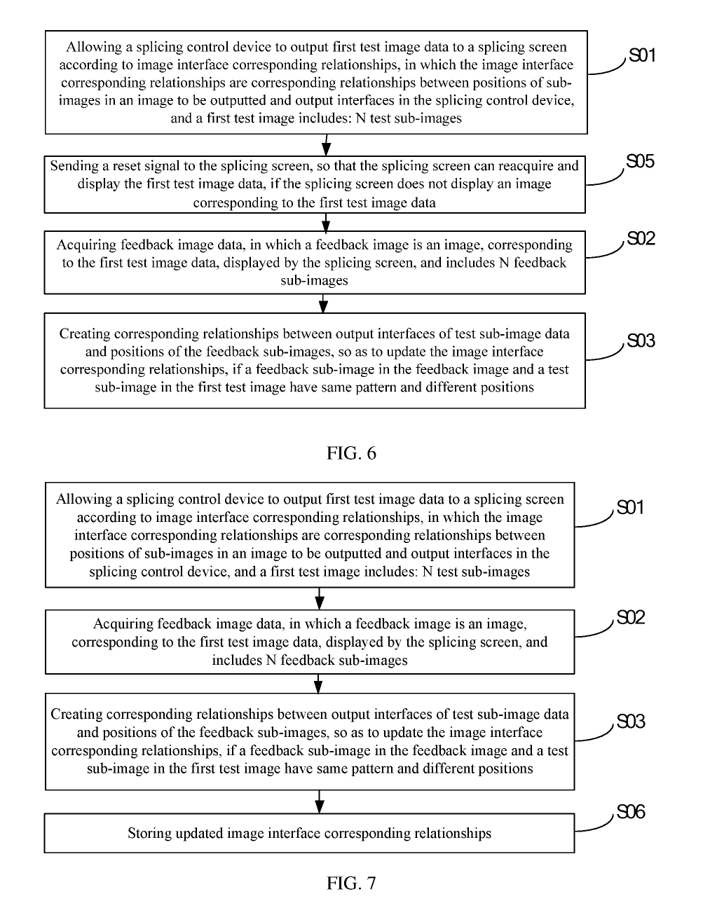

According to one example of the present disclosure, as shown in FIG. 6, after the step of allowing the splicing control device to output the first test image data to the splicing screen according to the image interface corresponding relationships in the step S01, if the splicing screen does not display an image corresponding to the first test image data, the method further comprises: S05: sending a reset signal to the splicing screen, so that the splicing screen can reacquire and display the first test image data. Thus, the control ability of the splicing control device on the splicing screen can be further improved.

According to one example of the present disclosure, as shown in FIG. 7, after the step of creating the corresponding relationships between the output interfaces of the test sub-image data and the positions of the feedback sub-images, so as to update the image interface corresponding relationships, in the step S03, the method further comprises: S06: storing updated image interface corresponding relationships.

According to one example of the present disclosure, after the step of creating the corresponding relationships between the output interfaces of the test sub-image data and the positions of the feedback sub-images, so as to update the image interface corresponding relationships, in the step S03, the method further comprises:

S07: allowing the splicing control device to output second test image data to the splicing screen according to the updated image interface corresponding relationships, so as to detect whether the updated image interface corresponding relationships are correct.

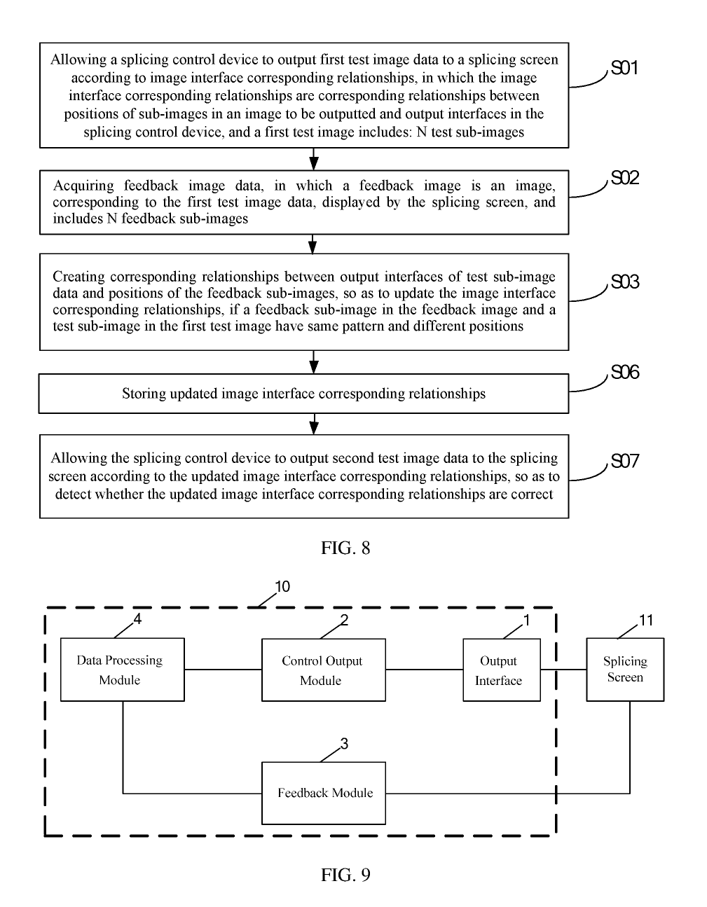

It should be noted here that the step S07 may be executed after the step S06 as shown in FIG. 8, and of course, may also be executed before the step S06. No limitation will be given here. The above method can ensure the correct adjustment of the image interface corresponding relationships, and hence can further improve the reliability.

Second Embodiment

The embodiment of the present disclosure provides a splicing control device. As illustrated in FIG. 9, the splicing control device 10 comprises:

Output interfaces 1. It should be noted that the number of the output interfaces is not limited in the embodiment of the present disclosure and may be determined according to actual conditions.

A control output module 2 configured to allow the splicing control device to output first test image data to a splicing screen 11 through the output interfaces according to image interface corresponding relationships. The image interface corresponding relationships are corresponding relationships between positions of sub-images in an image to be outputted and the output interfaces in the splicing control device. The first test image includes: N test sub-images. The meaning of the image interface corresponding relationships may refer to relevant description in the first embodiment. No further description will be given here.

A feedback module 3 configured to acquire feedback image data. A feedback image is an image, corresponding to the first test image data, displayed by the splicing screen, and includes N feedback sub-images. It should be noted that the feedback module may be an interface capable of receiving data information of the feedback image, and of course, may also be other circuit structures. No limitation will be given here.

A data processing module 4 configured to create corresponding relationships between output interfaces of test sub-image data and positions of the feedback sub-images, so as to update the image interface corresponding relationships, if one feedback sub-image in the feedback image and one test sub-image in the first test image have same pattern but different positions. It should be noted that the data processing module may be independently arranged in a data processing chip and may also be disposed in the conventional data processing chip in the splicing control device. No specific limitation will be given here.

The illustrative structures of the splicing control device in the embodiment of the present disclosure have been described above. It can be know by those skilled in the art according to the common knowledge and the prior art that the splicing control device may also be other structures. For instance, the splicing control device may further comprise a signal source for generating images or videos, a processor for converting signals outputted by a high definition multimedia interface (HDMI) or a digital visual interface (DVI) into signals capable of being recognized by the back end, an HD converter for converting an image or a video signal to be outputted into an HD signal, a processor for converting audio signals and video or image signals acquired from a universal serial bus (USB) interface into low-voltage differential signaling (LVDS) signals, etc. No further description will be given here.

The splicing control device provided by the embodiment of the present disclosure has been described above. The splicing control device comprises: output interfaces, a control output module, a feedback module and a data processing module. In the case of connection error between the splicing screen and the interfaces of the splicing control device, the splicing control device can automatically adjust output signals of the output interfaces, allow the splicing screen to display a correct pattern without repeated cable plugging, and hence can simplify operation and save time.

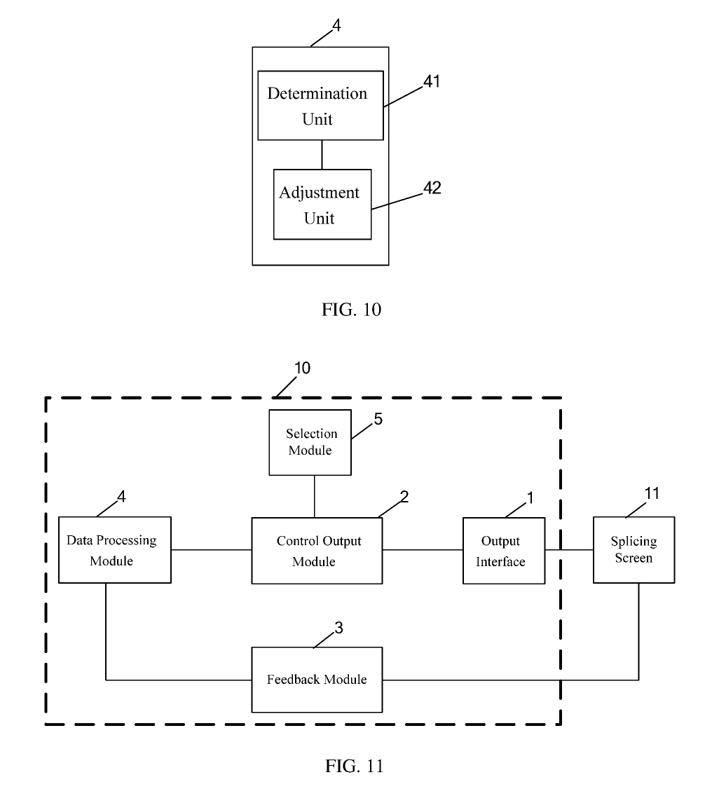

According to one example of the present disclosure, as shown in FIG. 10, the data processing module 4 may include:
a determination unit 41 configured to determine whether the feedback sub-image in the feedback image and the test sub-image in the first test image have same pattern but different positions; and
an adjustment unit 42 configured to create the corresponding relationships between the output interfaces of the test sub-image data and the positions of the feedback sub-images, so as to update the image interface corresponding relationships.

It should be noted that the determination unit and the adjustment unit may be a circuit unit integrated into a chip such as a microcontroller or a field programmable gate array (FPGA), and may also be an independent circuit structure. For instance, the determination unit may be an independent image processor. No limitation will be given to the specific circuit structure of the determination unit and the adjustment unit in the embodiment of the present disclosure, as long as the above functions can be satisfied.

According to one example of the present disclosure, as shown in FIG. 11, the splicing control device may further comprise:
a selection module 5 configured to select a first test image including N test sub-images according to N splicing sub-screens in the splicing screen.

No limitation will be given to the specific number of the test sub-images in the first test image in the embodiment of the present disclosure. Specifically, if the splicing screen includes 9 sub-screens, a first test image including 9 test sub-images is selected. The number of the test sub-images in the first test image is equal to the number of the splicing sub-screens in the splicing screen.

For instance, the selection module may be a toggle switch. The toggle switch is a hand-operated micro-switch, can be used to operate and control addresses, adopts the 0/1 binary coding principle, has a simple structure, and is convenient in use. Of course, the selection module may also be other circuit structures. No specific limitation will be given here. The splicing control device may provide first test images including test sub-images of different numbers, and hence can be applied in splicing screen systems including sub-screens of different numbers. Thus, the application scope of the splicing control device can be widened.

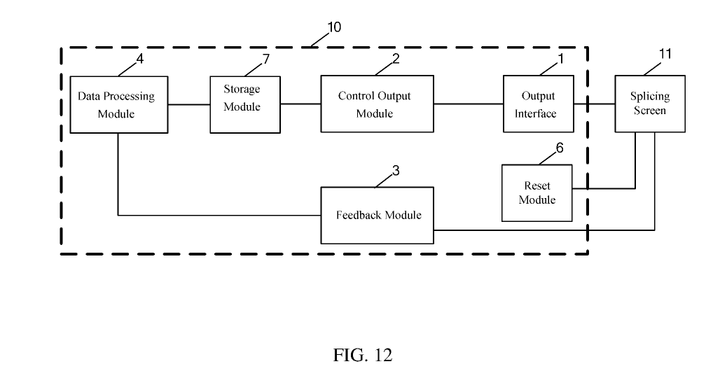

According to one example of the present disclosure, as shown in FIG. 12, the splicing control device may further comprise:
a reset module 6 configured to send a rest signal to the splicing screen if the splicing screen does not display an image corresponding to the first test image data, so that the splicing screen can reacquire and display the first test image data. The reset module may be a button and may also be a remote controller, and of course, may also be other structures. No specific limitation will be given here. Thus, the control ability of the splicing control device on the splicing screen can be further improved through the reset module.

According to one example of the present disclosure, as shown in FIG. 12, the splicing control device further comprises: a storage module 7 configured to store updated image interface corresponding relationships. The storage module may be an independent circuit structure such as a double data rate synchronous dynamic random access memory (DDR SDRAM), and of course, may also be other storage structures such as L1 Cache or L2 Cache integrated into a chip. No limitation will be given here.

Third Embodiment

The embodiment of the present disclosure provides a splicing screen system, which comprises the splicing control device provided by the second embodiment and a splicing screen. The type of the splicing screen is not limited here. The splicing screen may be composed of a plurality of liquid crystal displays (LCDs) and may also be composed of a plurality of organic light-emitting diode (OLED) displays. In the case of connection error between the splicing screen and the interfaces of the splicing control device, the splicing screen system can automatically adjust output signals of the output interfaces, allow the splicing screen to display a correct pattern without repeated cable plugging, and hence can simplify operation and save time.

According to one example of the present disclosure, the feedback module of the splicing control device may be connected with the splicing screen through a serial bus. For instance, the serial bus may be an inter-integrated circuit (I2C). The I2C is used for connecting a microcontroller and a peripheral device thereof, is a bus standard widely applied in the field of microelectronic communication control, is a special form of synchronous communication, and has the advantages of less interface lines, simple control mode, small component package form, high communication rate, etc.

What are described above is related to the illustrative embodiments of the disclosure only and not limitative to the scope of the disclosure. Obvious variations and replacement by any one of the skilled person in the art in the technical scope of the disclosure should be all covered in the scope of this disclosure. The scopes of the disclosure are defined by the accompanying claims.

The application claims priority to the Chinese patent application No. 201510729185.4, filed Oct. 30, 2015, the disclosure of which is incorporated herein by reference as part of the application.

1. A splicing control method, comprising:
outputting first test image data to a splicing screen according to image interface corresponding relationships, in which the image interface corresponding relationships refer to corresponding relationships between positions of sub-images in an image to be outputted and output interfaces of the splicing control device, and a first test image includes N test sub-images;
acquiring feedback image data, in which a feedback image is an image, corresponding to the first test image data, displayed by the splicing screen, and includes N feedback sub-images; and
creating corresponding relationships between output interfaces of test sub-image data and positions of the feedback sub-images, so as to update the image interface corresponding relationships, if a feedback sub-image in the feedback image and a test sub-image in the first test image have same pattern but different positions.

2. The method according to claim 1, wherein before the step of allowing the splicing control device to output the first test image data to the splicing screen according to the image interface corresponding relationships, the method further comprises:
selecting a first test image including N test sub-images according to N splicing sub-screens in the splicing screen.

3. The method according to claim 1, wherein after the step of allowing the splicing control device to output the first test image data to the splicing screen according to the image interface corresponding relationships, if the splicing screen does not display an image corresponding to the first test image data, the method further comprises:
sending a reset signal to the splicing screen, so that the splicing screen can reacquire and display the first test image data.

4. The method according to claim 1, wherein after the step of creating the corresponding relationships between the output interfaces of the test sub-image data and the positions of the feedback sub-images, so as to update the image interface corresponding relationships, the method further comprises:
storing updated image interface corresponding relationships.

5. The method according to claim 1, wherein after the step of creating the corresponding relationships between the output interfaces of the test sub-image data and the positions of the feedback sub-images, so as to update the image interface corresponding relationships, the method further comprises:
allowing the splicing control device to output second test image data to the splicing screen according to the updated image interface corresponding relationships, so as to detect whether the updated image interface corresponding relationships are correct.

6. A splicing control device, comprising:
output interfaces;
a control output module configured to output first test image data to a splicing screen through the output interfaces according to image interface corresponding relationships, in which the image interface corresponding relationships refer to corresponding relationships between positions of sub-images in an image to be outputted and the output interfaces, and the first test image includes: N test sub-images;
a feedback module configured to acquire feedback image data, in which a feedback image is an image, corresponding to the first test image data, displayed by the splicing screen, and includes N feedback sub-images; and
a data processing module configured to create corresponding relationships between output interfaces of test sub-image data and positions of the feedback sub-images, so as to update the image interface corresponding relationships, if one feedback sub-image in the feedback image and one test sub-image in the first test image have same pattern but different positions.

7. The device according to claim 6, wherein the data processing module includes:
a determination unit configured to determine whether the feedback sub-image in the feedback image and the test sub-image in the first test image have same pattern but different positions; and
an adjustment unit configured to create the corresponding relationships between the output interfaces of the test sub-image data and the positions of the feedback sub-images, so as to update the image interface corresponding relationships.

8. The device according to claim 6, wherein the splicing control device further comprises:
a selection module configured to select a first test image including N test sub-images according to N splicing sub-screens in the splicing screen.

9. The device according to 6, wherein the splicing control device further comprises: a reset module configured to send a reset signal to the splicing screen if the splicing screen does not display an image corresponding to the first test image data, so that the splicing screen can reacquire and display the first test image data.

10. The device according to claim 6, further comprising: a storage module configured to store updated image interface corresponding relationships.

11. A splicing screen system, comprising the splicing control device according to claim 6 and a splicing screen.

12. The system according to claim 11, wherein the feedback module of the splicing control device is connected with the splicing screen through a serial bus.

13. A splicing screen system, comprising the splicing control device according to claim 7 and a splicing screen.

14. A splicing screen system, comprising the splicing control device according to claim 8 and a splicing screen.

15. A splicing screen system, comprising the splicing control device according to claim 9 and a splicing screen.

16. A splicing screen system, comprising the splicing control device according to claim 10 and a splicing screen.
